(19) United States
(12) Patent Application Publication
(10) Pub. No.: US 2009/0023581 A1
(43) Pub. Date: Jan. 22, 2009

(54) THERMALLY STABLE DOPED AND UNDOPED POROUS ALUMINUM OXIDES AND NANOCOMPOSITE CeO2-ZrO2 AND Al2O3 CONTAINING MIXED OXIDES

(75) Inventors: Roberta Di Monte, Trieste (IT); Jan Kaspar, Trieste (IT); Stefano Desinan, Trieste (IT)

Correspondence Address: PEARNE & GORDON LLP, 1801 EAST 9TH STREET, SUITE 1200, CLEVELAND, OH, 44114-3108, US

(73) Assignee: Magnesium Elektron Limited, Salford (GB)

(21) Appl. No.: 11/813,035

(22) PCT Filed: Dec. 12, 2005
(86) PCT No.: PCT/GB2005/005110

§ 371 Date: May 15, 2008

(30) Foreign Application Priority Data
Dec. 30, 2004 (GB) 0428557.3

(51) Int. Cl. B01J 21/12; B01J 23/10; B01J 21/04

(52) U.S. Cl. 502/263; 502/355; 502/304; 502/303; 502/302

(57) ABSTRACT

The present invention relates to doped or undoped aluminas having after calcination at 1200° C. for 5-24 hours a pore volume ≧0.5 ml/g and a BET surface area greater then 35 m²/g. The invention also relates to a method for preparing these aluminas comprising the steps of: a. preparing an aqueous solution of an aluminum salt with optional co-dopants, b. treating the aqueous solution with hydrogen peroxide, c. precipitating the alumina using a base, and d. filtering, drying and calcining the alumina.

### BACKGROUND OF THE INVENTION

The present invention relates to development and synthesis of the alumina and alumina-containing nanocomposites. These products retain a high specific surface area, high oxygen storage and a nanocomposite nature when exposed to high temperatures due to their unique sintering properties, which allow the maintenance of a nano-sized grain size of the material even at high sintering densities.

Transitional aluminas are extensively used as catalytic supports for many catalytic applications and, in particular, in automotive gas exhaust catalysts due to their specific surface area. The activity of an alumina-supported catalyst depends on the specific surface area of the alumina. While supports containing transitional aluminas, e.g. γ-Al₂O₃, may be used for catalysts to effectively reduce nitrogen oxides and oxidize the carbon monoxide and hydrocarbons contained in exhaust gases, these supported catalysts are unstable when exposed to elevated temperatures.

In fact, at high temperatures, γ-Al₂O₃ rapidly undergoes a phase transition from γ-Al₂O₃ to the thermodynamically stable alpha phase with concomitant drastic decrease in specific surface area and loss of catalytic properties.

Additionally this phase transformation is accompanied by sintering, i.e. a particle grow and agglomeration process.

High-temperature-resistant composite catalysts are required, for example, in three-way exhaust catalyst and in catalytic materials for combustion in gas turbines. Al₂O₃ is a major component of these catalytic materials because it efficiently disperses the metals used as active centers in a very broad range of temperatures.

Porous substances are generally divided by pore size: those having pore sizes smaller than 2 nm are classified as microporous substances, between 2 and 50 nm are classified as mesoporous substances and larger than 50 nm are classified as macroporous substances. The texture of a porous substance, i.e. pore distribution and surface area, the latter being typically measured by the BET method, can be detected as described in a IUPAC (International Union of Pure and Applied Chemistry) report published in K. S. W. Sing, D. H. Everett, R. A. W. Haul, L. Moscou, R. A. Pierotti, J. Rouquerol, and T. Sieminiewska. Pure Appl. Chem. 57:603, 1985, from N₂ adsorption isotherms measured at 77 K. Typically, the so called BJH method is used to detect the pore distribution from the N₂ adsorption isotherm, which is described in the original publication: E. P. Barret, L. G. Joyner, and P. P. Halenda. J. Am. Chem. Soc. 73:373-380, 1951.

A study on the modification of the texture to produce aluminas stable at high temperatures is reported in A. C. Pierre, E. Elaloui, G. M. Pajonk, Langmuir 14:66-73, 1998. This study shows the possibility to achieve three different initial pore textures, generated by three different sol-gel synthesis procedure. The three synthesis procedures of thermally stable aluminas can be summarized as follows: (1) Drying by evaporation of the precursors (xerogels), leads to packing of the boehmite platelets with a high preferred orientation. The residual specific area at 1200° C. of such products is low (<1 m²/g). (2) Supercritical drying of the products obtained from a hydrolysis in an organic solvent using a mineral electrolyte as a pH modifier. In this case, mesopores and large macropores are obtained and preferred planar packing of boehmite platelets is avoided by blocking the solid network texture within a monolithic aerogel texture. This group of materials keeps a higher residual specific area at 1200° C., of the order of 10 m²/g. (3) The above prepared products are subjected to supercritical CO₂ technique (aerogels), which modify the alumina stability at high temperatures, leading to BET area of 33-70 m²/g after calcination at 1200° C. (compare also: E. Elaloui, A. C. Pierre, G. M. Pajonk, Journal of Catalysis, 166: 340-346, 1997). It is worth to notice that to achieve such good properties expensive precursors and complex post-treatments must be applied to the precipitated cake.

U.S. Pat. No. 6,403,526 produced alumina with high pore volume and high surface area. This invention discloses that when alumina trihydrate is dispersed and hydrothermally treated in the presence of controlled amounts of a dispersed active alumina seed component, high pore volume can be achieved in the product. In these conditions, after calcination at 537.8° C. for 2 h, products with BET surface area of 80 m²/g and a pore volume, as measured from N₂ adsorption, from about 0.2 to about 2.5 cc/9 are obtained.

U.S. Pat. No. 3,009,885 discloses that contacting hydrous alumina precursor, prior to calcination, with H₂O₂ improves the pore volume, BET area and thermal stability of γ-Al₂O₃. Pore volumes of about 0.5 ml/g were achieved after calcination at 1000 F for 6 h.

U.S. Pat. No. 6,214,312 discloses that high pore volumes, up to 1.44 ml/g, can be conferred to Al₂O₃ by use of surfactants in the synthesis. This method, however, represents the disadvantage of using costly materials for the synthesis.

Another solution to the problem of thermally unstable transitional alumina is described in U.S. Pat. No. 3,867,312, where a lanthanide series metal compound is added thereby forming an activated, stabilized catalyst support when calcined at elevated temperatures.

In WO 93/17968, doped aluminas with thermal stability are prepared. The stabilizer can be an oxide of barium, an oxide of a lanthanide metal, a compound of barium which is converted to an oxide upon heating at an elevated temperature. The reported examples show that addition of the dopant improves thermal stability to such a degree that BET areas up to 58 m²/g after calcination for 3 h at 1200° C. could be achieved.

Ceria (CeO₂) is a well-established alumina dopant, typically used in a quantity of up to 20% by weight of the catalyst. At lower proportions (e.g. <5-10%) and elevated temperatures (e.g. >900° C.) CeAlO₃ can be formed, but at higher ceria contents the Al₂O₃ and CeO₂ may segregate at the Al₂O₃ surface. Ceria can take up and release oxygen reversibly and so is said to have an oxygen storage capacity (OSC) that can assist CO and hydrocarbon oxidation under oxygen-lean conditions. However, previous observations (see for example: T. Miki, T. Ogawa, A. Ueno, S. Matsuura and M. Sato, Chem. Lett. 1988, 565 and J. Z. Shyu, W. H. Weber and H. S. Gandhi, J. Phys. Chem. 1988, 92, 4964) and patent claims (see for example U.S. Pat. No. 5,945,369, issued on Aug. 31, 1999) clearly indicated the unsuitability of impregnation of CeO₂ on Al₂O₃ for production of effective OSC systems because the high dispersion and intimate contact of the CeO₂ component with Al₂O₃ favors, upon ageing, formation of CeAlO₃ that deactivates the OSC component. Accordingly, it is usual practice to employ pre-formed CeO₂ or CeO₂—ZrO₂ particles to make the TWCs. These particles are then supported (washcoated) on Al₂O₃.

In exhaust systems catalysts are required to remove by chemical reaction the main pollutants, i.e. carbon monoxide (CO), hydrocarbons (HC) and nitrogen oxide (NOₓ), contained in car exhaust gases, and an oxygen storage component (OSC) is incorporated in such systems to extend the range of conditions of effective operation of the catalyst. The gases of a car exhaust vary from being “rich” (i.e. reducing conditions) to “lean” (i.e. oxidizing conditions). Under rich conditions the oxygen required to oxidize the CO and HC components is provided by the OSC. When the system changes to lean conditions the OSC is oxidized by the gases so that it can again provide oxygen when rich conditions are encountered.

Ceria, especially when doped with precious metal catalyst such as Pd, shown a great tendency to lose surface area when exposed to high temperatures, e.g. 800° C. or above, and the overall performance of the catalyst is degraded. Because of this, TWC's are being proposed and introduced in the markets which use, instead of ceria as the oxygen storage component, ceria-zirconia mixed oxides, which are much more stable to loss of surface area than ceria alone. Addition of further elements to the CeO₂—ZrO₂ may further improve the thermal stability of this component.

Accordingly, nowadays the OSC components generally contain a solid solution of ceria and zirconia, preferably with at least one other component. The addition of alumina to ceria and zirconia increase the thermal stability, providing the possibility to use these systems at high temperature. The problem of these systems is the durability with the time, since the availability of ceria changes with the time and conditions of use.

U.S. Pat. No. 6,326,329 claims preparation of substantially uniform mixed CeO₂—ZrO₂ mixed oxides on Al₂O₃ by a deposition method but such a could not be applied to broad compositional intervals, further to say is that significant amounts of α-Al₂O₃ were formed after ageing at 1140° C., showing that such a undesirable transformation of the Al₂O₃ could not be prevented.

U.S. Pat. Nos. 6,150,288 and 6,306,794 disclose preparation of composite oxides containing CeO₂—ZrO₂ and Al₂O₃ claiming that a solid solution of CeO₂—ZrO₂ can be formed which is intermixed with an Al₂O₃ phase, however, such composites showed quite poor thermal resistance as denoted by BET areas that do not exceed 85 m²/g after calcination at 1000° C. for 5 h.

The OSC's performance under these oxidation and reduction conditions are often measured by Temperature Programmed Reduction (TPR) whereby a sample of OSC material is heated at a constant rate in a stream reducing gas, such as hydrogen, and the amount of reaction effected by the sample monitored as a function of the gas stream composition. A typical result is shown in FIG. 1A. The main features of this TPR measurement are the temperature reached at the peak maximum of the reaction (Tₘₐₓ) and the area under the trace, which is proportional to the amount of the OSC that is reduced. The typical value of Tₘₐₓ for conventional OSCs is about 450-600° C. The exact value of Tₘₐₓ for a given OSC is dependent on the exact composition of the OSC and the particular protocol of TPR used. OSC can also be measured using different reducing agent and, in particular, using alternate pulses of CO as reducing agent and O₂ oxidising agent. This latter measurement in often denominated as kinetic or dynamic-OSC. To be noticed that CO is oxidized to CO₂ in this latter measurement and therefore the catalytic capability to promote oxidation reaction is contemporarily measured in this way.

The term nanocomposite material is used to describe materials composed of agglomerated particles that feature different crystallographic properties and/or composition or can be an amorphous phase, which are contained in a matrix, where at least one of these components feature particle sizes of few to few-hundreds nanometer, preferably with an average particle size of between 2 and 400 nm (1 nanometer=1 nm=10⁻⁹ m). Particle size in such materials can typically be measured from the powder XRD patterns, by using the Schrerrer line broadening method.

The terms nanosized material or nanomaterial is used to describe materials composed of particles of few to few-hundreds nanometer (1 nanometer=1 nm=10⁻⁹ m) in size, where the term particles can also be referred to the grain of which the materials is composed. The calculation of the grain size is defined in the subsequent text.

### SUMMARY OF THE INVENTION

The present invention relates to synthesis of doped or undoped aluminas and alumina-containing nanocomposite materials with high pore volume and high surface area. The alumina is stabilized by doping amounts of base, rare-earth elements, alkaline or alkaline-earth elements, and retains a high specific surface area when exposed at elevated temperatures. The alumina content is in the range 100-20 wt %.

The second part of this invention concerns development of improved catalytic materials, and more especially it concerns improved catalyst components containing CeO₂, which can be used as oxygen storage components for catalytic converters for automobile exhaust system, which posses high thermal stability and improved oxygen storage.

The third part of this invention provides a method of treating a ceria-doped alumina nanocomposite material prepared by supporting or co-synthesizing CeO₂ with alumina or aluminate or hexaluminate, optionally doped with other elements, in order to further improve the thermal stability and low temperature performance as an oxygen storage component of an exhaust gas purification system.

Whereas these systems can be conveniently used as oxygen storage components in the automotive catalysts, they could also conveniently be employed in a number of different catalytic processes requiring high thermal stability and/or efficient redox properties such as supports for catalysts for hydrocarbon processing such as steam reforming and partial oxidation reactions to produce H₂ rich streams or as precursors for advanced ceramic materials.

The doped or undoped aluminas of the present invention have after calcination at 1200° C. for 5 to 24 hours a pore volume greater than or equal to 0.5 ml/g and a BET surface area greater than 30 m²/g, preferably greater than 50 m²/g and most preferably greater than 60 m²/g. Preferably the alumina is an alumina-containing nanocomposite material. The preferred particle size for the alumina is 2 to 400 nm. It is preferred that that the alumina has a ratio gs_{ρ} to gs_{30%}<20 for relative densities 80<ρ<98%.

It is preferred that the alumina comprises a nanosized doped or undoped CeO₂—ZrO₂ mixed oxide and a nanosized doped or undoped alumina, wherein more than 50% of the particles of the ceria-zirconia phase are smaller than 30 nm and more than 50% of the particles of the alumina phase are smaller than 15 nm after calcination at 1100° C. for 5 hours.

The preferred doped or undoped aluminas of the present invention have after calcination at 1200° C. for 5 hours a BET surface area greater than 50 m²/g, most preferably 70 m²/g.

It is preferred that the alumina is doped with at least one of barium, lanthanum or a rare earth element. It is further preferred that no α-Al₂O₃ can be detected by the XRD technique after calcination of the alumina at 1200° C. for at least 5 hours.

The preferred doped or undoped aluminas of the present invention have after calcination at 1100° C. for 5 hours a BET surface area greater than 75 m²/g., preferably greater than 100 m²/g.

The alumina of the present invention is preferably composed of a nanosized doped or undoped CeO₂—ZrO₂ mixed oxide and doped or undoped alumina, where the OSC performance as measured by the CO pulse technique is deactivated by less than 20% after a simulated ageing consisting of a redox cycle consisting of an TPR experiment, followed by an oxidation at 427° C. or 1000° C.

The preparation method of the present invention comprises the following steps:
a. preparing an aqueous solution of an aluminium salt with optional co-dopants,
b. treating the aqueous solution with hydrogen peroxide,
c. precipitating the alumina using a base, and
d. filtering, drying and calcining the alumina.

The preferred aluminium salt is aluminium nitrate. The preferred base is ammonia, sodium hydroxide or potassium hydroxide. Preferably the method involves washing the alumina with alcohol, preferably iso-propanol, and filtering it between steps c and d. Preferably the method includes a hydrothermal treatment step between steps c and d, and after the alcohol wash step if one is carried out. The hydrothermal treatment step is preferably carried out for between 4 and 24 hours, preferably using water, iso-propanol or acetone. A further wash with acetone may be carried out after the hydrothermal treatment step and before step d. The drying step is preferably carried out at 120-180° C. The calcination is preferably carried out at 500-700° C.

A preferred dopant for the alumina is CeO₂. Other preferred dopants, either in addition to or instead of CeO₂, are oxides of one or more of the rare earth metals, alkali metals, alkali earth metals, Zr or Si.

FIG. 2 shows a typical scheme for such a synthetic procedure.

Including a salt of a dopant in the aqueous solution may further stabilize the alumina, produced according to the present invention.

The final concentration of dopant in the γ-alumina is about 0 to 15 mol %.

When such doped aluminas are further calcined at high temperatures, alluminates or hexaalluminates may be formed and therefore this procedure allows preparation of such compounds as well.

Another aspect of the present invention is that when several cations, even as many as five different species chosen, for example, among Al, Ce, Zr, La and Ba are allowed to react together, nanocomposite systems can be prepared where, as detected by powder X-ray technique, Ba—Al and Ce—Zr—La components selectively react to form a nanocomposite mixed oxides, in which the Ba—Al component mutually interact to form, upon calcination, a thermally stable doped allumina, which can be in the form of a hexylluminate of alluminate; whereas the other components (Ce—Zr—La) selectively react to form a segregated phase, as detected by the XRD pattern, consisting of a mutual solid solution. This latter component is then acting as a highly efficient and thermally stable OSC promoter.

Subsequently, the present invention provides a method of treating a material containing alumina, doped alumina, hexyluminate or aluminate. This method may also comprise modifying at least some of the surface of the material by contact with an aqueous solution of the hydrogen peroxide or other leaching agents as described in a recent PCT application (PCT/GB2003/004495).

The treatment should be such as to modify at least some of the surface of the material to an extent sufficient to cause a significant lowering of the Tₘₐₓ temperature of the material.

It has been found that the surface modifications effected by the method of the present invention do not modify the thermal stability of the samples to a significant extent.

### BRIEF DESCRIPTION OF THE DRAWINGS

Examples of the present invention will now be described with reference to the accompanying drawings, in which:

FIG. 1 shows TPR profiles of a conventional (A) and an advanced (B) OSC material as reported in PCT application

FIG. 2 shows a scheme of a typical synthesis methodology employed in the present invention,

FIG. 3 shows a comparison of the N₂ adsorption-desorption isotherms and, cumulative pore volume and pore distribution calculated using the BJH method, using the isotherms measured over the samples prepared as reported in Examples 1, 2 and 4,

FIG. 4 shows a comparison of the N2 adsorption-desorption isotherms and, cumulative pore volume and pore distribution calculated using the BJH method, using the isotherms measured over the samples prepared as reported in Examples 6 and 6 a,

FIG. 5 shows sintering trajectories measured over several Examples,

FIG. 6 shows powder XRD patterns measured on the Al0.96La0.11O1.5 (prepared as reported for Example 9 using appropriate molar ratios) and Al0.96La0.04O1.5 (Example 9). The bottom trace is not relevant to the present application.

FIG. 7 shows powder XRD patterns measured on the Al0.96Ba0.04O1.48 (Example 8), Ce0.2Zr0.802(50% wt)/Al2O3.

### DESCRIPTION OF THE PREFERRED EMBODIMENTS

As a part of our investigation into preparation of thermally stable composite oxides containing alumina we discovered a novel methodology for synthesis of aluminas with high surface area, high pore volume and high thermal stability.

This method is applicable for synthesis of doped or undoped aluminas with high thermal stability.

This method is applicable for synthesis of ceria-zirconia solid solution (doped or undoped) supported on alumina (doped or undoped). The alumina or doped alumina content is in the range 100-20% wt.

The method of the present invention comprises one or more of the following steps:
a) preparing a mixture of an aqueous solution of an aluminum salt and optionally doping elements and addition of hydrogen peroxide (or mixture of the aqueous solution of an aluminum salt and optionally doping elements and addition of hydrogen peroxide and a preformed nanometer-scale solid solution),
b) performing an co-precipitation, preferably inverse, by adding the above solution to basic solution containing ammonia or other bases, organic or inorganic.
c) the solid product is filtered and preferably washed with water, an alcohol or acetone or other suitable solvents and then preferably thermally treated in water or an alcohol or other suitable solvent for 5-24 h at 100-250° C.,
d) the obtained solid is filtered, optionally washed, for example with acetone, and dried, typically at 120° C. for 1-4 h,
e) finally the dried product is calcined, typically at 700° C. for 5 h.

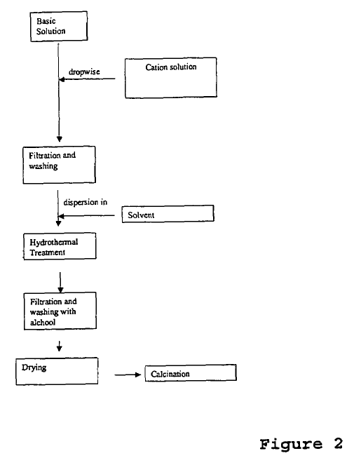

A typical synthesis scheme is summarised in FIG. 2.

Such products feature remarkably high pore volumes, typically as high as ca. 3 ml/g⁻¹, and a pore distribution in a meso to macropore region. These factors confer high thermal stability to the product compared to state of art transitional alluminas, as shown by the data reported in Table 1.

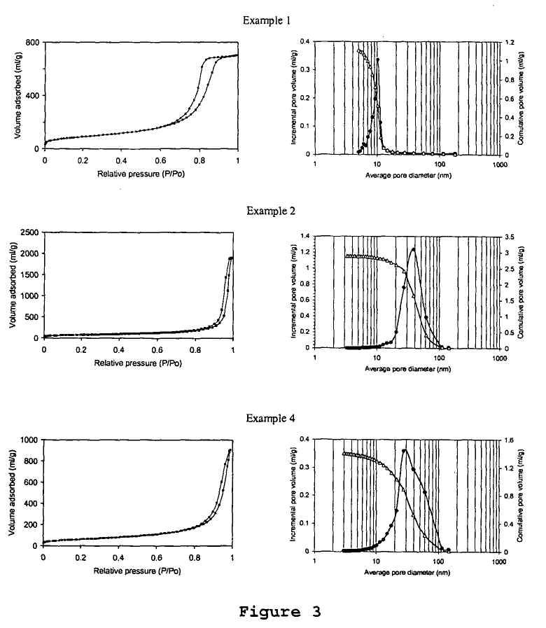

The addition of hydrogen peroxide (FIG. 3, compare examples 1 and 2) is an important aspect of the present invention. U.S. Pat. No. 3,009,885 reports that addition of hydrogen peroxide can be used to increase the surface area and/or pore volume of hydrous alumina metal oxide. However, unexpectedly we observed according to the according to the present invention, that H₂O₂ must preferentially be added in the first stage of the synthesis, optionally followed by the treatment with the organic solvents; this leads to heavily modified pore distribution with remarkable increase of pore volume and pore radii with respect to conventional preparations (Examples 3 and 3a). The modification of the pore distribution is an important factor for the stabilization of the surface at high temperatures.

Such modified pore properties lead to a very remarkably property of the present aluminas, which is the observed textural stability of the products even for very long calcination times at temperatures as high as 1200° C.

It has been observed that the increasing the cristallinity of the boehmite phase may increase the thermal stability of the θ-Al₂O₃ (compare: X. Bokhimi, J. A. Toledo-Antonio, M. L. Guzmán-Castillo, B. Mar-Mar, F. Hernández-Beltrán and J. Navarrete, Journal of Solid State Chemistry 161, 2001, 319 and T. Tsukayuda, H. Segawa, A. Yasumori and K. Okada, J. Mat. Chem. 9, 1999, 549). In fact, in another embodiment of the present invention is observed that when a thermal post-treatment either in alcohol or water is carried out on samples prepared as described in the present invention, a further remarkable stabilization of surface area and pore volumes of the present aluminas can be achieved even for calcination temperatures as high as 1200° C. (FIG. 3, compare examples 2 and 4). Very remarkably, with respect to the state of art, the effects of the H₂O₂ added to the initial solution persisted even after hydrothermal treatment carried out at 180° C. for 20 h, leading to novel nanomaterials with advanced properties as described in the following.

It is observed that the modification of the particle size and texture of the product as induced by the present treatments and synthesis route, modify the stability at high temperatures.

Accordingly, the alumina of the present invention when annealed at 1200° C. for 5-24 hours has a specific area, as measured by the BET method, preferable higher than 35 m²/g, more preferable about or higher than 50 m²/g, even more preferable about or higher than 60 m²/g. Very remarkably, such high thermal stability can be achieved by using the present cost-effective methodology, without addition of any dopant to the Al₂O₃ precursor.

The doped alumina that can be prepared by this procedure is preferably a mixed oxide composed of 100-80 mol % of aluminum and 0-20 mol % of a second component comprising the oxide of one or more of the rare earth metals, especially Pr, La, and one or more of the alkaline earth metals (Mg, Ca, Sr, Ba, etc.). The latter component is particularly effective in achieving high thermal stability of the doped Al₂O₃. More then one dopant can be added during the preparation of the doped Al₂O₃ to further improve its properties.

An important aspect of the present invention is that H₂O₂ must be added at an appropriate ratio, dependent on the specific composition of the material produced, during the synthesis and preferably added to the starting solution of the metal cations.

In another embodiment of the present invention, the above described route was applied to preparation of an multi-component CeO₂—ZrO₂—BaO—Al₂O₃ mixed oxide. When such product was subsequently calcined at very high temperatures (1000-1300° C.), thermally stable and highly effective nanocomposite CeO₂-containing OSC promoters were obtained. Surprisingly, the co-precipitated mixed oxides form segregated CeO₂—ZrO₂ and BaO—Al₂O₃ phases where the presence of BaO provides an effective way to prevent the undesirable deactivation of the OSC component due to formation of CeAlO₃, as checked by dynamic OSC measurements. This protection is particularly effective when this nanocomposite oxide is treated under a sequence of redox treatments consisting of a TPR experiment followed by a medium/high temperature oxidation, where almost no deactivation of the OSC of the present oxide is observed, particularly when calcined at 1100° C. and using high contents of ZrO₂. In contrast, significant deactivation of OSC is observed over similar mixed oxides not containing BaO.

A fundamental embodiment of the present invention is the fact that when the nanocomposite material is prepared, by coprecipitation of more then the three basic metal precursors, i.e. ceria, zirconia and alumina, a preferential distribution of the cations is achieved allowing selective stabilization against sintering of the different phases contained within the nanocomposite material.

Very surprisingly, this segregation of the different phases, leading to a nanocomposite allumina-OSC promoter system was achieved even when 5 different cations were co-precipitated, where La could selectively introduced into the CeO₂—ZrO₂ solid solution increasing its thermal stability.

A further aspect of the present invention is that crystallographically pure barium hexyluminate phase can be easily obtained in the nanocomposite system upon calcination, whereas it is known that co-precipitation routes typically do not lead to pure hexaalluminates, BaAl₂O₄ being always observed as an intermediate product during the calcination.

Subsequently, the present invention provides a method of treating a material containing alumina, doped alumina, hexyluminate or aluminate. This method comprises modifying at least some of the surface of the material by contact with an aqueous solution of the hydrogen peroxide, or other etching solutions as described in a recent patent application (PCT/GB2003/004495).

The treatment should be such as to modify at least some of the surface of the material to an extent sufficient to cause a significant lowering of the Tₘₐₓ temperature of the material compared to the untreated product.

It has been also found that the surface modification effected by the method of the present invention does not modify the thermal stability of the nanocomposite CeO₂ and Al₂O₃ containing OSC material.

It is known that the addition of barium and lanthanum to alumina-ceria mixed oxides during their synthesis helps block the entry of cerium into the alumina lattice. It is desirable to prevent this migration because once the cerium is in the alumina lattice its catalytic function is reduced since it cannot be re-oxidised from the +3 to the +4 oxidation state. However, in the present invention it has been surprisingly found that barium and lanthanum provide the same effect in a nanocomposite.

### EXAMPLES

In the following examples aluminium nitrate, barium and lanthanum nitrates, Ce(NO₃)₃.6H₂O or a cerium containing solution prepared from a carbonates that were dissolved in water and HNO₃, and ZrO(NO₃)₂ (nominal content 20 wt % of ZrO₂, MEL Chemicals) were used as metal precursors. Examples 1 and 6a report control experiments performed without addition of H₂O₂ in the synthesis whereas the other examples reports syntheses performed according to the present invention.

Examples 2-6 represents different possibilities to produce thermally stable Al₂O₃ as disclosed in the present invention, whereas examples 7-11 describe preparation of doped Al₂O₃.

### Example 1

### Control Experiment TLDAl100

A 0.60 M solution of Al(NO₃)₃ (160 ml) was prepared from reagent grade Al(NO₃)₃.9H₂O and distilled water. This solution is added to 60 ml of ammonia solution (30% wt) under stirring. The rate of addition is around 2.5 ml/min. The suspension is then aged for further 30 minutes and filtered. The obtained solid is dispersed in iso-propanol (400 ml) and filtered.

The solid is further dispersed in iso-propanol (400 ml) and heated at 80° C. over night. After cooling and filtration, the solid is dispersed in acetone (400 ml), filtered and dried at 120° C. for 4 h. The obtained powder is calcined at 700° C. for 5 h. The heating rate is 3° C./min.

### Example 2

### TLC(VII) Al100

A 0.75 M solution of Al(NO₃)₃ (130 ml) was prepared from reagent grade Al(NO₃)₃.9H₂O and distilled water; 30 ml of H₂O₂ (30% wt) are added to this solution. The obtained solution is then added to 60 ml of ammonia (30% wt). The solid is further dispersed in water (400 ml) and heated at 100° C. over night. After cooling, the solid is filtered and dried at 120° C. over night. The obtained powder is calcined at 700° C. for 5 h. The heating rate is 3° C./min.

### Example 3

### TLC(III) Al100

A 0.75 M solution of Al(NO₃)₃ (130 ml) was prepared from reagent grade Al(NO₃)₃.9H₂O and distilled water. 30 ml of H₂O₂ (30% wt) are added to this solution. The obtained solution is then added to 60 ml of ammonia (30% wt) and further processed as described in Example 1.

### Example 3a

### Control Experiment TLAl100

A sample was prepared as reported in example 3 with the exception that H₂O₂ was added to the suspension obtained further to addition of the cation solution to the ammonia solution, i.e. H₂O₂ is added to the precipitate.

### Example 4 TLC(XVI) Al100

30 ml H₂O₂ (30% wt) are added to the following solution: 0.755 M of Al(NO₃)₃ (130 ml), prepared from reagent grade Al(NO₃)₃.9H₂O and distilled water. The resulting solution is then added to 75 ml of the ammonia (30% wt). The rate of addition is around 2.5 ml/min. The suspension is filtered; and twice washed as described: the solid is dispersed in 400 ml water with 10 ml ammonia (30% wt) and 10 ml hydrogen peroxide (30% wt) and then filtered. The solid is then dispersed in 400 ml water with 10 ml ammonia (30% wt) and 10 ml hydrogen peroxide (30% wt) and heated at 100° C. for 3 days. After cooling and filtration, the solid is dispersed in iso-Propanol (400 ml) and then filtered. The solid is dispersed once more in iso-Propanol (400 ml) and left at 25° C. over night. After filtration, the solid is dispersed in acetone (400 ml), filtered, dried at 120° C. for 4 h and finally calcined at 700° C. for 5 h. The heating rate is 3° C./min.

### Example 5

### TLC(XVIII) Al100

30 ml H₂O₂ (30% wt) are added to the following solution: 0.755 M of Al(NO₃)₃ (130 ml), prepared from reagent grade Al(NO₃)₃.9H₂O and distilled water. The resulting solution is then added to 75 ml of the ammonia (30% wt). The rate of addition is around 2.5 ml/min. The suspension is filtered. The solid is dispersed, two times, in 400 ml water with 10 ml ammonia (30% wt) and 10 ml hydrogen peroxide (30% wt) and then again filtered. The solid is dispersed once more in water (100 ml) and heated in hydrothermal conditions (Tₘₐₓ=125° C. for 17 h; Pₘₐₓ=9 bar).

After cooling and filtration, the solid is dispersed in iso-propanol (400 ml) and then again filtered. The solid is dispersed once more in iso-propanol (400 ml) and heated at 25° C. over night. After filtration, the solid is dispersed in acetone (400 ml), filtered, dried at 120° C. for 4 h and finally calcined at 700° C. for 5 h. The heating rate is 3° C./min.

### Example 6

### TLC(XXI) Al100

30 ml H₂O₂ (30% wt) are added to the following solution: 0.755 M of Al(NO₃)₃ (130 ml), prepared from reagent grade Al(NO₃)₃.9H₂O and distilled water. The resulting solution is then added to 75 ml of the ammonia (30% wt). The rate of addition is around 2.5 ml/min. The suspension is filtered; the solid is dispersed, two times, in 400 ml water with 10 ml ammonia (30% wt) and 10 ml hydrogen peroxide (30% wt) and then again filtered. The solid is dispersed in 400 ml water with 10 ml ammonia (30% wt) and 10 ml hydrogen peroxide (30% wt) and heated at 100° C. for over night. After filtration, the solid is dispersed once more in water (100 ml) and heated in hydrothermal conditions (Tₘₐₓ=180° C. for 19 h; Pₘₐₓ=12 bar). After cooling, the solid is dispersed in iso-Propanol (400 ml) and then again filtered. The solid is dispersed once more in iso-propanol (400 ml) and heated at 85° C. over night. After treatment, the solid are dried with the rotavapor and finally calcined at 700° C. for 5 h. The heating rate is 3° C./min.

### Example 6a

### Control Experiment (TLD(XXI)Al100)

An experiment was performed using the procedure described for example 6, without, however, adding H₂O₂ to the starting solution.

### Example 7

### Synthesis of Al_{0.96}Ba_{0.04}O_{1.46}. TLC(III) Al96Ba4

30 ml H₂O₂ (30% wt) are added to the following solution: 0.67 M of Al(NO₃)₃ and 0.028 M of Ba(NO₃)₂ (130 ml), prepared from reagent grade Al(NO₃)₃.9H₂O, Ba(NO₃)₂ and distilled water. The resulting solution is then added to 53 ml of the ammonia (30% wt). The rate of addition is around 2.5 ml/min. After 30 minutes of aging, the suspension is filtered, the solid is dispersed in iso-Propanol (400 ml) and then again filtered. The solid is dispersed once more in iso-propanol 99.5% (400 ml) and heated at 80° C. over night. After cooling and filtration, the solid is dispersed in acetone 99% (400 ml), filtered, dried at 120° C. for 4 h and finally calcined at 700° C. for 5 h. The heating rate is 3° C./min.

### Example 8

### Synthesis of Al_{0.96}Ba_{0.04}O_{1.46}. BaAl1.23

A solution containing 0.867 M of Al(NO₃)₃ and 0.038 M Ba(NO₃)₂ (250 ml) is added to 175 ml of ammonia (30% wt). The rate of addition is 2.5 ml/min. 24 ml H₂O₂ 30% wt are added and the system is aged for 30 minutes; the suspension is filtered and washed three times with diluted ammonia, the solid is dispersed in iso-propanol (1000 ml), shaken overnight, filtered, dispersed again in iso-propanol (1000 ml) and heated at 80° C. for 4 h. After cooling and filtration, the solid is dispersed in acetone (1000 ml), filtered, dried at 120° C. for 5 days and finally calcined at 700° C. for 5 h. The heating rate is 3° C./min.

### Example 9

### Synthesis of Al_{0.96}La_{0.04}O_{1.5}. LaAl1.23

A solution containing 0.818 M of Al(NO₃)₃ and 0.036 M La²⁺ (40 ml) is added to 184 ml of ammonia (15% wt). The rate of addition is 2.5 ml/min. The temperature is lowered to 5° C. with an ice bath; 4 ml H₂O₂ 30% wt are added and the system is aged for 30 minutes; the suspension is filtered; the solid is dispersed in iso-propanol (50 ml), filtered, dispersed again in iso-propanol (300 ml) and heated at 80° C. for 4 h. After cooling and filtration, it is dried at 120° C. for 5 h and finally calcined at 700° C. for 5 h. The heating rate is 3° C./min.

### Example 10

### Synthesis of Al_{0.92}Ba_{0.08}O_{1.46}. TLC(III) Al92Ba8

30 ml H₂O₂ (30% wt) are added to the following solution: 0.75 M of Al(NO₃)₃ and 0.052 M of Ba(NO₃)₂ (130 ml), prepared from reagent grade Al(NO₃)₃.9H₂O, Ba(NO₃)₂ and distilled water. The resulting solution is then added to 50 ml of the ammonia (30% wt). The rate of addition is around 2.5 ml/min. After 30 minutes of aging, the suspension is filtered; the solid is dispersed in iso-propanol (400 ml) and then again filtered. The solid is dispersed once more in iso-propanol (400 ml) and heated at 80° C. over night. After cooling and filtration, the solid is dispersed in acetone (400 ml), filtered, dried at 120° C. for 4 h and finally calcined at 700° C. for 5 h. The heating rate is 3° C./min.

### Example 11

### Synthesis of Al_{0.88}Ba_{0.12}O_{1.44}. TLC(III) Al88Ba12

30 ml H₂O₂ (30% wt) are added to the following solution: 0.75 M of Al(NO₃)₃ and 0.052 M of Ba(NO₃)₂ (130 ml), prepared from reagent grade Al(NO₃)₃.9H₂O, Ba(NO₃)₂ and distilled water. The resulting solution is then added to 50 ml of the ammonia (30% wt). The rate of addition is around 2.5 ml/min. After 30 minutes of aging, the suspension is filtered; the solid is dispersed in iso-propanol (400 ml) and then again filtered. The solid is dispersed once more in iso-propanol (400 ml) and heated at 80° C. over night. After cooling and filtration, the solid is dispersed in acetone (400 ml), filtered, dried at 120° C. for 4 h and finally calcined at 700° C. for 5 h. The heating rate is 3° C./min.

The thermal stability of each of the powder produced in Example 1 and 11 was tested by annealing the powders at 1200° C. for 5 hours at a heating rate of 0.5 or 3° C./min. For each example, the phase composition was determined by x-ray diffraction powder analysis (XRD), the specific surface area was measured by the BET method and the cumulative pore volume detected from the BJH method.

TABLE 1
Textural properties of the aluminas prepared
according to the present invention. All samples were
calcined for 5 h.

| | Calcination temperature [heating rate 0.5 or | | | | | | | |
|---|---|---|---|---|---|---|---|---|
| | 3° C./min] | | | | | | | |
| | 700° C. [3] | | | 1200° C. [3] | | 1200° C. [0.5] | | |
| | | Pore | | | Pore | | Pore | % |
| | BET | Volume | ps₍₄₀₀₎ | BET | Volume | BET | Volume | α- |
| Example | (m²/g) | (cc/g) | (nm) | (m²/g) | (cc/g) | (m²/g) | (cc/g) | Al₂O₃ |
| Example 1 | 323 | 1.11 | | 7 | 0.07 | 6 | 0.03 | 100 |
| Example 2 | 231 | 0.61 | | 19 | 0.27 | 17 | 0.28 | 100 |
| Example 3 | 317 | 2.60 | 3.0 | 21 | 0.15 | 36 | 0.36 | 41 |
| Example | 313 | 0.92 | | 4 | 0.02 | | | |
| 3a | | | | | | | | |
| Example 4 | 254 | 1.41 | 4.2 | 51 | 0.54 | 63 | 0.68 | 8 |
| Example 5 | 226 | 1.41 | 3.6 | 61 | 0.79 | 60 | 0.73 | |
| Example 6 | 122 | 0.85 | 6.2 | 56 | 0.40 | 59 | 0.65 | 0 |
| Example | 193 | 0.56 | | 45 | 0.27 | 43 | 0.26 | |
| 6a | | | | | | | | |
| Example 7 | 305 | 2.88 | | 80 | 0.89 | 74 | 1.21 | |
| Example 8 | 329 | 1.38 | | 76 | 0.52 | | | |
| Example 9 | 326 | 1.94 | | 33 | 0.46 | | | |
| Example | 271 | 2.95 | | 96 | 1.03 | 110 | 0.66 | |
| 10 | | | | | | | | |
| Example | 241 | 2.79 | | 80 | 0.96 | 81 | 0.94 | |
| 11 | | | | | | | | |

The data reported in Table 1 indicate that the method reported in the present invention produced aluminas with high specific surface area even after annealing at 1200° C. for 5 hours.

The addition of H₂O₂ in the starting solution remarkably improves thermal stability of the present products with respect to conventional materials prepared by an inverse co-precipitation, as revealed by the values observed on samples prepared according to examples 1, 3a and 2, 3. This effect is dramatically apparent when the above described synthesis procedure includes the step of the treatment in an alcohol (Example 3), where high pore volumes in addition to high thermal stability is achieved In fact, the present synthesis method is capable to remarkably modify the pore structure (textural properties) of the present materials with respect to the reference example 1 (FIG. 3). In particular the pore distribution shown in this Figure reveals that pores with much higher radii, compared to conventional materials, are prepared by the present invention, which leads to enhanced thermal stability of the product.

This modified pore distribution persisted even when the sample has been subjected to a hydrothermal treatment as reported in Example 6, showing that significantly higher pore volume has been attained according the present synthesis procedure (Example 6) compared to a control sample (Example 6a) (compare Table 1)

The particle size measure along the (400) direction is reported in Table 1, showing the nanometer dimension of the present materials.

The XRD patterns were measured on samples prepared in example 1-6 after calcination at 1200° C. The analysis of these patterns revealed significant amount of α-Al₂O₃ being produced in the calcination (Table 1); very remarkably, the data obtained for the sample prepared according to the Example 6 reveal that the hydrothermal treatment further improves thermal stability of the present alumina, preventing the undesirable formation of α-Al₂O₃.

A very remarkably high value of BET area (110 m²/g) is achieved for the Ba-doped alumina after calcination at 1200° C., as shown by the data reported for Example 10.

An important aspect of the present findings are the sintering properties of the materials that appear neatly modified with respect to the state-of-art knowledge. For many applications, such as for example preparation of advanced ceramic materials maintenance of constant grain size up to very high densities during the sintering process is a key property leading to advanced materials. To assess the effects of sample properties on the sintering mechanism and the presence of advanced-favourable properties, the use of the so-called sintering trajectories, as described in detail in J. Kanters, U. Eisele, and J. Rodel. Effect of initial grain size on sintering trajectories. Acta Materialia 48 (6):1239-1246, 2000. and refs. therein, is an useful methodology. A sintering trajectory is represented by a plot of normalized grain size vs. relative density. For this purpose the grain size (gs) and relative densities (ρ) can be calculated as reported in the following text. Grain size is calculated as:

$$B E T = \frac{6000}{g s \cdot {ρ}_{bulk}}$$

Accordingly, a normalized grain size is defined as:

$$\frac{g {s}_{ρ}}{g {s}_{30 \%}} = \frac{B E {T}_{ρ}}{B E {T}_{30 \%}}$$

where gs_{ρ} represents a grain density at a given density of the material and gs_{30%}represents the grain size at a density ρ=30%.

The relative density is calculated from the textural data by using the following relationships:

$$\frac{1}{{ρ}_{gel}} = {V}_{p} + \frac{1}{{ρ}_{bulk}}$$

$$and$$

$${ρ}_{rel} ( \% ) = \frac{{ρ}_{gel}}{{ρ}_{bulk}} \cdot 100$$

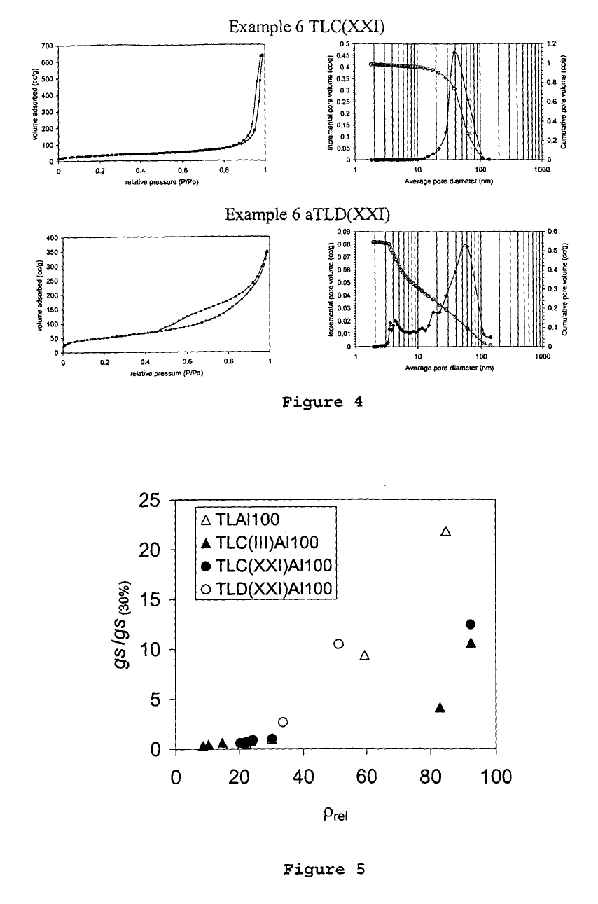

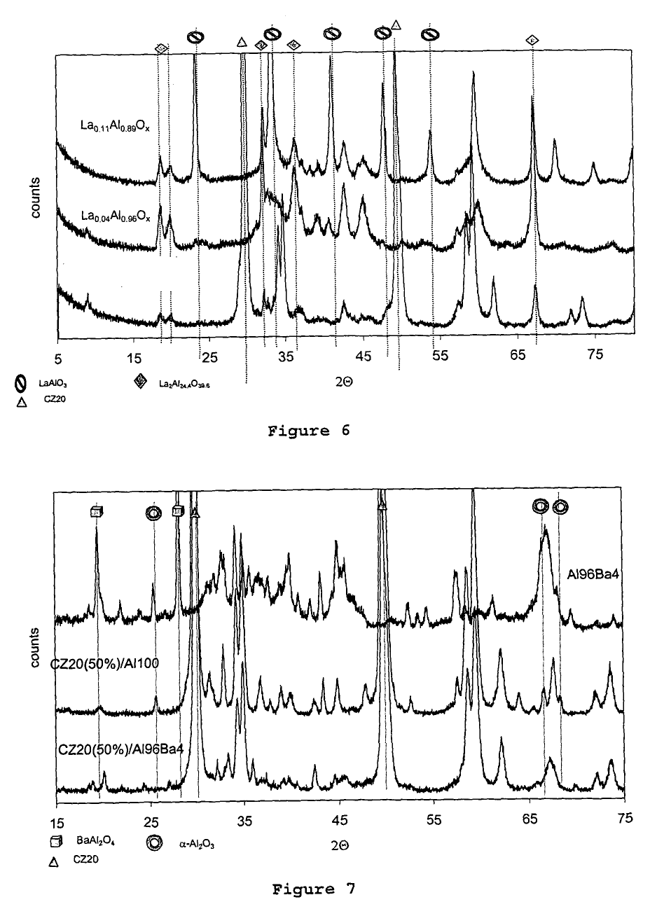

As shown in FIG. 5, sintering trajectories reported for the two control experiments show that a very strong increase of the relative grain size occurs in the case of the conventional materials, where a ratio of gs_{ρ} to gs_{30%}>20 is observed at low relative densities (<60%), which is an indication of unfavourable sintering properties of such conventional materials. In contrast, sintering of the present unconventional nanomaterials leads to nanosized Al₂O₃ particles even at very high relative densities (>80%), as demonstrated by the ratios gsp to gs_{30%}<20. Comparison of such ratios for the present materials, comparative examples and some commercial materials is reported in Table 2.

These advanced sintering properties make these materials of strong interest not only n the field of catalysis but also in other fields such as preparation of advanced ceramics.

TABLE 2
gs_{ρ}/gs_{30%} ratio measured over advanced nanosized
Al₂O₃ materials as disclosed in the present invention,
comparative examples and commercial Al₂O₃.

| | δᵣₑₗ | |
|---|---|---|
| Sample | (80 < δᵣₑₗ < 95) | gs_{ρ}/gs_{30%} |
| Example 3 invention | 83 | 4 |
| Example 6TLC(XXI)Al100 | 92 | 12 |
| invention | | |
| TLAl100 control | 85 | 22 |
| Example 6aTLD(XXI)Al100 | 51 | 10 |
| control | | |
| MI307 (Grace ™) | 80 | 22 |
| MI407 (Grace ™) | 98 | 72 |
| NGa150 (Sassol ™) | 93 | 39 |
| HP14 (Sassol ™) | 93 | 25 |

As shown by the XRD patterns reported in FIG. 4, the structural properties of the presently synthesized materials present a number of remarkable features: a nanocomposite materials is prepared where phase segregated OSC material and lanthanum doped allumina (a hexaalluminate phase) are formed. The formation of such nanocomposite prevents formation of α-Al₂O₃ despite the very high temperature of calcination. Also to be noticed, the unprecedented observation that use of lower amount of the La dopant favours direct formation of the hexylluminate phase, preventing formation of lanthanum aluminate.

The XRD patterns reported in FIG. 7 show similar remarkable features where the present synthesis method allows preparation of nanocomposite materials with neatly segregated CeO₂—ZrO₂ solid solution from the alumina containing phase; further to observe is the fact that again formation of a barium hexaalluminate phase is favoured in the nanocomposite system over the barium aluminate phase.

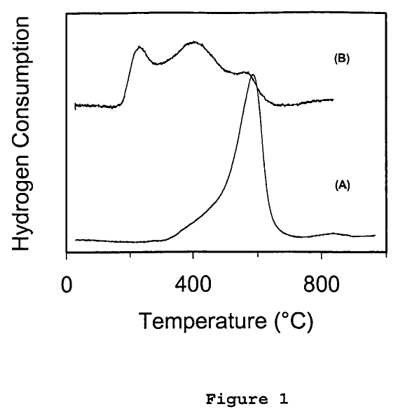

It is worth noting that production of a nanocomposite material as described in the resent invention, improves the redox behaviour of the OSC component with respect to conventional CeO₂—ZrO₂ OSC materials as documented by comparison of the TPR profiles of the conventional materials (FIG. 1) with respect to those here reported.

1. A doped or undoped alumina having after calcination at 1200° C. for 5-24 hours a pore volume ≧0.5 ml/g and a BET surface area greater than 30 m²/g wherein the alumina is an alumina-containing nanocomposite material containing within its matrix agglomerated particles of more than one crystallographic phase.

2. An alumina as claimed in claim 1, wherein the BET surface area is greater than 50 m²/g.

3. An alumina as claimed in claim 2, wherein the BET surface area is greater than 60 m²/g.

4. (canceled)

5. An alumina as claimed in claim 1, having an average particle size of between 2 and 400 nm.

6. An alumina as claimed in claim 1, having a ratio gs_{ρ}, to gs_{30%}, <20 for relative densities 80<ρ<98%.

7. An alumina as claimed in claim 1, comprising a nanosized doped or undoped CeO₂—ZrO₂ mixed oxide phase and a nanosized doped or undoped alumina phase, wherein more than 50% of the particles of the ceria-zirconia phase are smaller than 30 nm and more than 50% of the particles of the alumina phase are smaller than 15 nm after calcination at 1100° C. for 5 hours.

8. An alumina as claimed in claim 1, having after calcination at 1200° C. for 5 hours a BET surface area greater than 50 m²/g.

9. An alumina as claimed in claim 8, wherein the BET surface area is greater than 70 m²/g.

10. An alumina as claimed in claim 1, wherein the alumina is doped with at least one of barium, lanthanum or a rare earth element.

11. An alumina as claimed in claim 1, wherein no α-Al₂O₃ can be detected by XRD technique after calcination of the material at 1200° C. for at least 5 hours.

12. An alumina as claimed in claim 1, having after calcination at 1100° C. for 5 hours a BET surface area greater than 75 m²/g.

13. An alumina as claimed in claim 12, wherein the BET surface area is greater than 100 m²/g.

14. An alumina as claimed in claim 1, composed of a nanosized doped or undoped CeO₂—ZrO₂ mixed oxide phase and doped or undoped alumina phase, where OSC performance as measured by CO pulse technique is deactivated by less than 20% after a simulated ageing consisting of a redox cycle consisting of an TPR experiment, followed by an oxidation at 427° C. or 1000° C.

15. A method of preparing thermally stable transitional alumina comprising the following steps:
a. preparing an aqueous solution of an aluminium salt,
b. treating the aqueous solution with hydrogen peroxide,
c. precipitating the alumina using a base, and
d. filtering, drying and calcining the alumina at a temperature and for a time sufficient to produce a doped or undoped alumina having after calcination at 1200° C. for 5-24 hours a pore volume ≧0.5 ml/g and a BET surface area greater than 30 m²/g wherein the alumina is an alumina-containing nanocomposite material containing within its matrix agglomerated particles of more than one crystallographic phase.

16. A method as claimed in claim 15, wherein the aluminum salt is aluminium nitrate.

17. A method as claimed in claim 15, wherein the base is ammonia, sodium hydroxide or potassium hydroxide.

18. A method as claimed in claim 15, wherein the precipitation is an inverse precipitation.

19. A method as claimed in claim 15, wherein the method includes the step of washing the alumina with alcohol and filtering it between steps c and d.

20. A method as claimed in claim 19, wherein the alcohol is iso-propanol.

21. A method as claimed in claim 19, wherein the method includes a hydrothermal treatment step between steps c and d, but after said alcohol washing step.

22. A method as claimed in claim 21, wherein the hydrothermal treatment is carried out for between 4 and 24 hours.

23. A method as claimed in claim 21, wherein the hydrothermal treatment step is carried out using water, iso-propanol or acetone.

24. A method as claimed in claim 21, wherein the alumina is washed with acetone following the hydrothermal treatment step.

25. A method as claimed in claim 15, wherein the alumina is dried at between 120° C. and 180° C.

26. A method as claimed in claim 15, wherein the alumina is calcined at between 500° C. and 700° C.

27. A method as claimed in claim 15, wherein the alumina is doped with CeO₂.

28. A method as claimed in claim 15, wherein the alumina is doped with oxides of one or more of the rare earth metals, alkali metals, alkali earth metals, Zr or Si.

29. A method as claimed in claim 15 wherein said aqueous solution includes co-dopants.

30. A doped or undoped alumina prepared by a method as claimed in claim 15 having after said calcination at 1200° C. for 5-24 hours said pore volume ≧0.5 ml/g and said BET surface area greater than 30 m²/g wherein the alumina is said alumina-containing nanocomposite material containing within its matrix agglomerated particles of more than one crystallographic phase.
